(19) United States
(12) Patent Application Publication
(10) Pub. No.: US 2016/0350785 A1
(43) Pub. Date: Dec. 1, 2016

(54) SHOPPING ASSISTANT SYSTEM AND METHOD

(71) Applicants: Kevin Hwading Chu, Houston, TX (US); Wei Song, Houston, TX (US); Xiran Wang, West Lafayette, IN (US)

(72) Inventors: Kevin Hwading Chu, Houston, TX (US); Wei Song, Houston, TX (US); Xiran Wang, West Lafayette, IN (US)

(73) Assignee: Imagine If, LLC, Houston, TX (US)

(21) Appl. No.: 14/742,507

(22) Filed: Jun. 17, 2015

Related U.S. Application Data
(60) Provisional application No. 62/168,623, filed on May 29, 2015.

(51) Int. Cl. G06Q 30/02

(52) U.S. Cl. CPC G06Q 30/0222; G06Q 30/0234

(57) ABSTRACT

A system including a server, including a processor and a database, and a computing device configured to issue a request to the server. The database is configured to store purchase information. The processor, upon receiving the request, is configured to: determine a category of a purchase having a purchase price, apply the purchase information to the purchase to maximize a first value, identify a coupon having a second value that reduces the purchase price, apply the coupon to reduce the purchase price by the second value, and display, on the computing device, a reduced value.

### RESERVATION OF COPYRIGHTS

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Resources such as coupons, rebates, promotions, etc., are widely available for shoppers to exploit. However, today's shoppers want to purchase products/services (P/S) conveniently, efficiently, and confidently.

### SUMMARY

In general, in one aspect, one or more embodiments disclosed herein relate to a server having a processor and a database; and a computing device configured to issue a request to the server, wherein the database is configured to store purchase information, and wherein the processor, upon receiving the request, is configured to: determine a category of a purchase having a purchase price, apply the purchase information to the purchase to maximize a first value, identify a coupon having a second value that reduces the purchase price, apply the coupon to reduce the purchase price by the second value, and display, on the computing device, a reduced value.

In another aspect, one or more embodiments disclosed herein relate to a method comprising: determining that a user is at a checkout page for a purchase; determining a category of the purchase having a purchase price; applying a purchase information stored in a database to the purchase to maximize a first value; identifying a coupon having a second value that reduces the purchase price; applying the coupon to reduce the purchase price by the second value; and displaying a reduced value.

In yet another aspect, one or more embodiments disclosed herein relate to a non-transitory computer readable medium comprising computer readable program code, which when executed by a computer processor, enables the computer processor to: determine that a user is at a checkout page for a purchase; determine a category of the purchase having a purchase price; apply a purchase information stored in a database to the purchase to maximize a first value; identify a coupon having a second value that reduces the purchase price; apply the coupon to reduce the purchase price by the second value; calculate, using at least one of the first value and the second value, a first total value; compare, using emulation, the first total value to an other total value; display, if the first total value is not greater than the other total value, an alternative purchase; display, if the first total value is greater than the other total value, the reduced value; display a promotion associated with the purchase using merchant information; and display an advertisement associated with the purchase using the merchant information.

Other aspects and advantages of the present invention will be apparent from the following description and the appended claims.

### BRIEF DESCRIPTION OF DRAWINGS

FIG. 1 shows a shopping assistant system according to one or more embodiments of the present invention.

FIG. 2A shows a computing device according to one or more embodiments of the present invention.

FIG. 2B shows a computing device according to one or more embodiments of the present invention.

FIG. 2C shows a computing device according to one or more embodiments of the present invention.

FIG. 2D shows a computing device according to one or more embodiments of the present invention.

FIG. 3A shows a shopping assistant server according to one or more embodiments of the present invention.

FIG. 3B shows a portion of a shopping assistant server according to one or more embodiments of the present invention.

FIG. 3C shows a portion of a shopping assistant server according to one or more embodiments of the present invention,

FIG. 3D shows a portion of a shopping assistant server according to one or more embodiments of the present invention.

FIG. 4A shows a shopping assistant method according to one or more embodiments of the present invention.

FIG. 4B shows a shopping assistant method according to one or more embodiments of the present invention.

FIG. 5 shows a shopping assistant method according to one or more embodiments of the present invention.

FIG. 6 shows a shopping assistant method according to one or more embodiments of the present invention.

FIG. 7 shows a shopping assistant method according to one or more embodiments of the present invention.

FIG. 8A shows a shopping assistant method according to one or more embodiments of the present invention,

FIG. 8B shows a shopping assistant method according to one or more embodiments of the present invention.

FIG. 8C shows a shopping assistant method according to one or more embodiments of the present invention.

FIG. 8D shows a shopping assistant method according to one or more embodiments of the present invention.

FIG. 9A shows an application associated with the shopping assistant system of FIG. 1.

FIG. 9B shows an application associated with the shopping assistant system of FIG. 1.

FIG. 9C shows an application associated with the shopping assistant system of FIG. 1.

FIG. 9D shows an application associated with the shopping assistant system of FIG. 1.

FIG. 9E shows an application associated with the shopping assistant system of FIG. 1.

### DETAILED DESCRIPTION

Specific embodiments will now be described in detail with reference to the accompanying figures. Like elements in the various figures are denoted by like reference numerals for consistency. Like elements may not be labeled in all figures for the sake of simplicity.

In the following detailed description, numerous specific details are set forth in order to provide a more thorough understanding of one or more embodiments of the present invention. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.)

may be used as an adjective for an element (i.e., any noun in the application). The use of ordinal numbers is not to imply or create a particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

The terms and words used in the following disclosure and claims are not limited to the bibliographical meanings, but are merely used by the inventor to enable a clear and consistent understanding of one or more embodiments of the present invention. Accordingly, it should be apparent to those skilled in the art that the following description of one or more embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

In general, one or more embodiments of the present invention relate to a shopping assistant system. In general, one or more embodiments of the present invention relate to a shopping assistant method. In general, one or more embodiments of the present invention relate to a shopping assistant method. In general, one or more embodiments of the present invention relate to a non-transitory computer readable medium comprising computer readable program code.

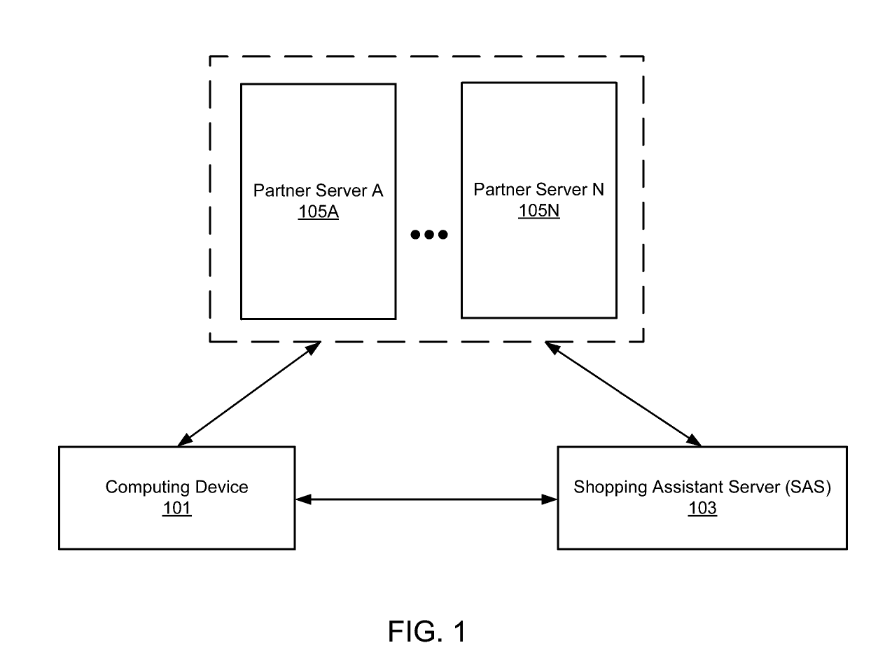

FIG. 1 shows a shopping assistant system according to one or more embodiments of the present invention. As shown in FIG. 1, the system has multiple components including one or more computing devices (101), a shopping assistant server (SAS) (103), and one or more partner servers (105A, 105N). As also shown in FIG. 1, various components of the system may communicate directly or indirectly with one another. The communication may be exchange of information, storage of information, etc. The information within the shopping assistant system described herein may be stored in one or more data structures. Further, any data structure type (e.g., arrays, linked lists, hash tables, etc.) may be used to organize information within the data structure(s) provided that the data structure type(s) maintain the various exchange of information described. Each of these components is described below.

In one or more embodiments of the present invention, the computing device (101) may be a desktop personal computer (PC), a laptop, a tablet computer, an electronic reader (e-reader), a cable box, a kiosk, a smart phone, a server, a mainframe, a personal digital assistant (PDA), or any other type of hardware device. Each device may include a processor, persistent storage, and a memory. The device may communicate (directly or indirectly) with the SAS (103) and/or the one or more partner servers (105A, 105N) using any wired and/or wireless (e.g., wifi, cellular, etc.) connections.

In one or more embodiments of the disclosure, the computing device (101) may also include one or more input device(s) (not shown), such as a touchscreen, keyboard, mouse, microphone, touchpad, electronic pen, or any other type of input device. Further, the computing device (101) may include one or more output device(s) (not shown), such as a screen (e.g., a liquid crystal display (LCD), a plasma display, touchscreen, cathode ray tube (CRT) monitor, projector, or other display device, a printer, external storage, or any other output device. One or more of the output device(s) may be the same or different from the input device(s). Many different types of computing systems exist, and the aforementioned input and output device(s) may take other forms.

In one or more embodiments, the SAS (103) may be implemented on hardware device that includes a memory and a processor. The SAS (103) is operatively connected to the computing device (101) and the one or more partner servers (105A, 105N).

In one or more embodiments, the one or more partner servers (105A, 105N) are third party servers separate from the SAS server (103). That is, the one or more partner servers (105A, 105N) are servers belonging to different entities than the SAS server (103). In one or more embodiments, the one or more partner servers (105A, 105N) may be associated with, for example, advertisers, product/service (P/S) providers, coupon issuers, promotion issuers, and financial institutions that issue credit cards, debit cards, 3^{rd} party entities, etc.

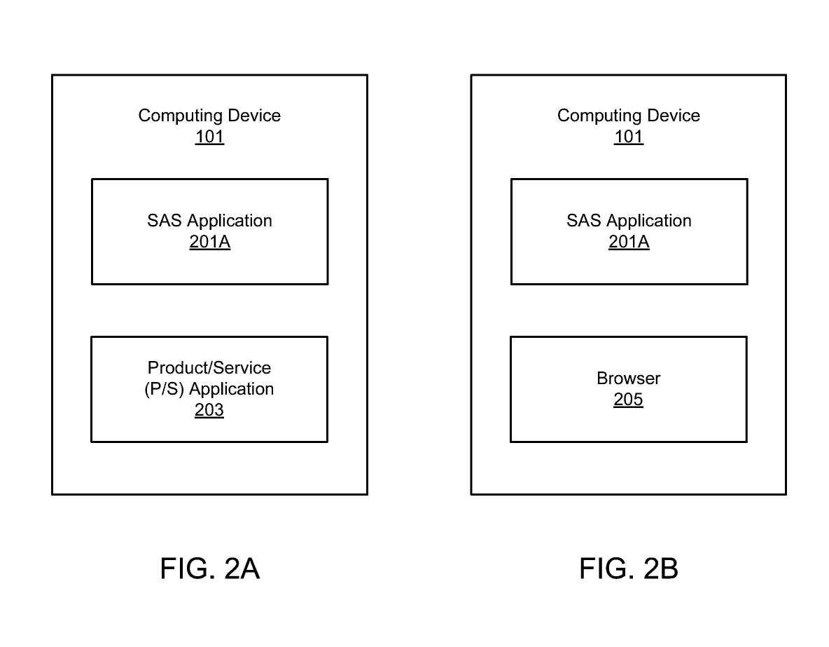

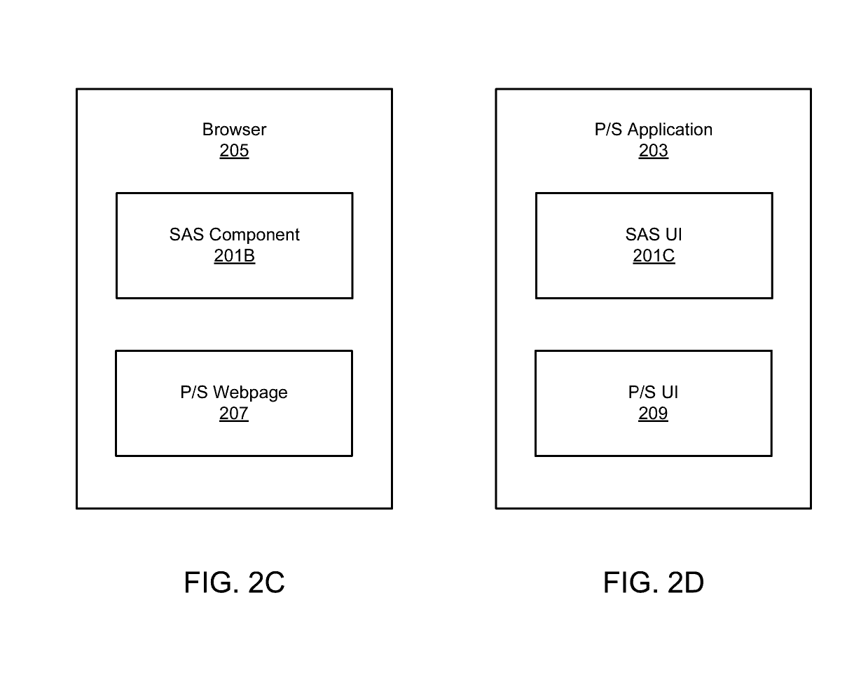

FIG. 2A shows a computing device (101) according to one or more embodiments of the present invention. Specifically, FIG. 2A shows that the computing device (101) is executing an SAS application (201A) and a P/S application (203). The SAS application (201A) is associated with the SAS server (103) and the P/S application (203) is associated with the one or more partner servers (105A, 105N).

FIG. 2B shows a computing device (101) according to one or more embodiments of the present invention. Specifically, FIG. 2B shows that the computing device (101) is executing an SAS application (201A) and a browser (205). The SAS application (201A) is associated with the SAS server (103). The browser (205) is a software application for retrieving, presenting, and traversing information resources on the World Wide Web. One of ordinary skill in the art would appreciate that an information resource is identified by a uniform resource identifier (URI/URL). Further, one of ordinary skill in the art would appreciate that Firefox, Internet Explorer, Google Chrome, Opera, and Safari are just some of the available browsers.

FIG. 2C shows a computing device according to one or more embodiments of the present invention. Specifically, FIG. 2C shows that the browser (205) may further comprise an SAS component (201B) that is associated with the SAS server (103) and a P/S webpage (207) associated with the one or more partner servers (105A, 105N). The SAS component (201B) may be a tag a script, an extension, a plug-in, etc.

FIG. 2D shows a computing device according to one or more embodiments of the present invention. Specifically, FIG. 2D shows that the P/S application (203) associated with the one or more partner servers (105A, 105N) may further comprise an SAS User Interface (UI) associated with the SAS server (103) and a P/S UI associated with the one or more partner servers (105A, 105N).

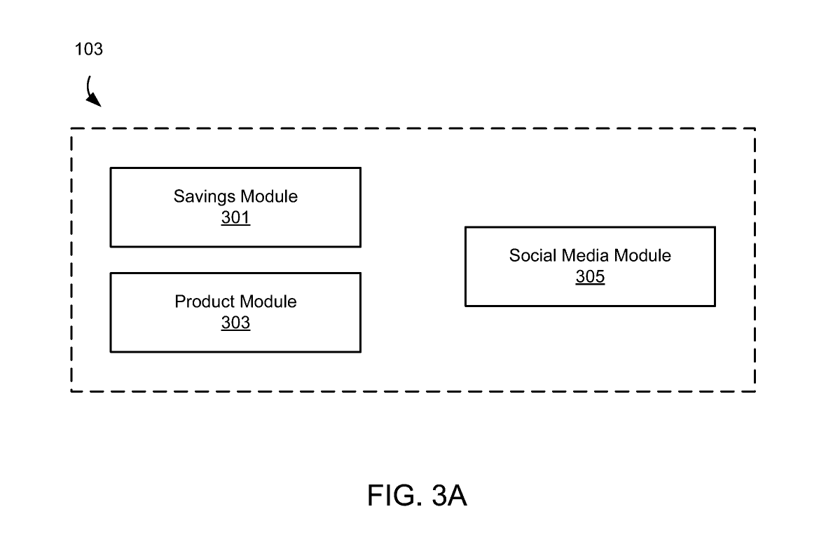

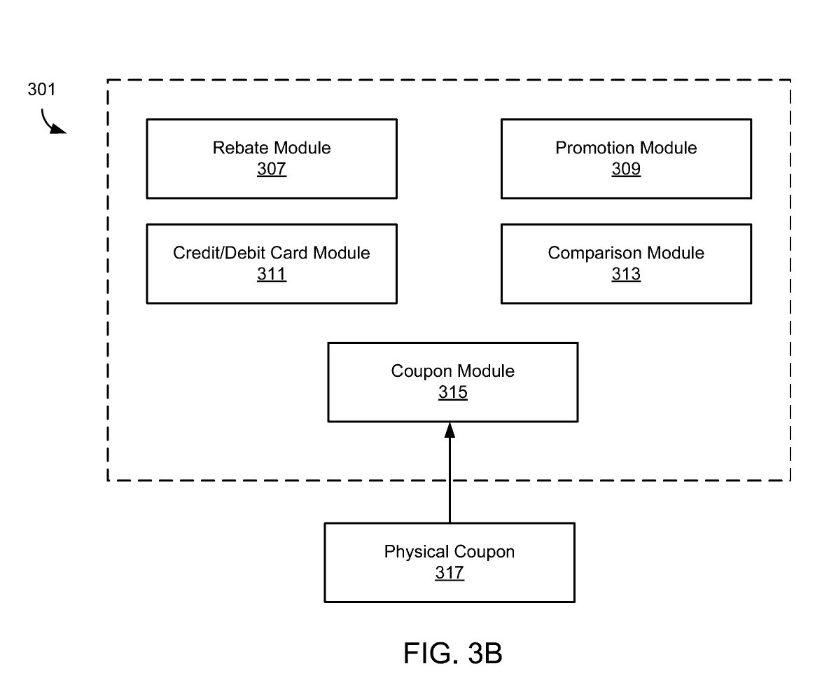

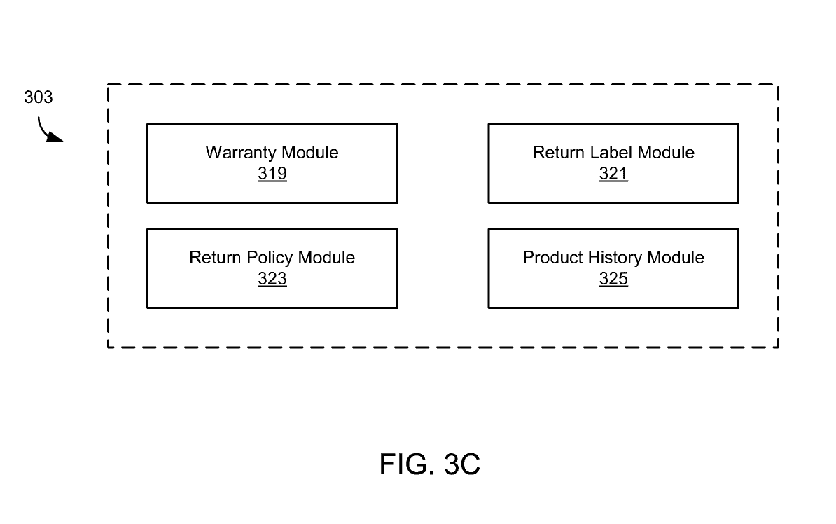

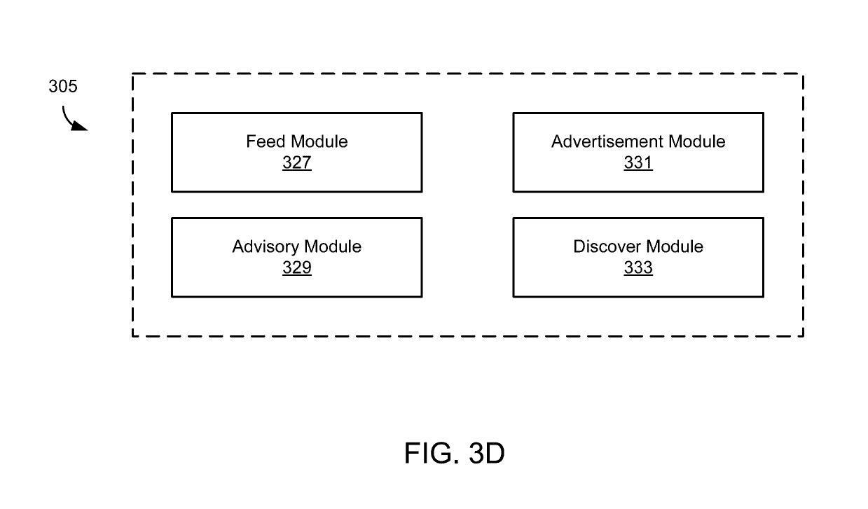

FIG. 3A shows a shopping assistant server (103) according to one or more embodiments of the present invention. As discussed above, the SAS server (103) may be a hardware having a processor and a memory. Additionally, as shown in FIG. 3A, the SAS server (103) may comprise a savings module (301), a product module (303), and a social media module (305). One of ordinary skill in the art would appreciate that the modules may be a part of the processor or may each be a processor. Further, one of ordinary skill in the art would appreciate that the various components of the SAS (103) may each communicate directly and/or indirectly using any means with the one or more partner servers (105A, 105N) and the computing device (101).

FIG. 3B shows a portion of a shopping assistant server (103) according to one or more embodiments of the present invention. Specifically, FIG. 3B shows some components of the savings module (301), which may include a rebate module (307), a promotion module (309), a credit/debit card module (311), a comparison module (313), and a couple module (315).

In one or more embodiments, the rebate module (307) may be configured to determine whether a rebate is available with respect to a purchase request sent by the computing device (101). As will be described below, a user may interact with the computing device (101) in a certain manner that causes the computing device (101) to submit a purchase request to the SAS server (103) and/or the one or more partner servers (105A, 105N). The rebate module (307) may, upon the user completing a purchase, obtain unique identification codes from the one or more partner servers (105A, 105N) and create electronic vouchers. The electronic vouchers may be stored on the computing device (101) and may be printed, submitted, used, etc., by the user to earn a rebate from the purchase.

In one or more embodiments, the promotion module (309) may be configured to determine whether a promotion is available with respect to the purchase. For example, if the SAS (103) determines that the purchase comprises a jar of pickles, the promotion module (309) may determine whether a promotion is available with respect to the jar of pickles. Examples of promotions may be: buy a first jar and get a second jar free; buy a first jar and get half off a second jar. For purposes of this application, complementary goods promotions are also considered promotions. Consider that a jar of salsa costs $5.00 and a bag of chips costs $3.00. Further consider that there is currently a promotion indicating that the combination of the jar of salsa and the bag of chips is priced at $6. The promotion module (309), based on the request from the computing device (101), may determine that the user has bought either the jar of salsa or the bag of chips but not both and prompt the user with information pertaining to the promotion (i.e., indicating that the other may be bought in combination at a discount).

In this application, “promotion” is to be differentiated from “advertisement.” In specific instances, a promotion may be an advertisement and an advertisement may be a promotion, but this relationship need not hold. A promotion is to be tied specifically to a purchase. For example, as discussed above, when buying salsa, one may be provided with a promotion for a bag of chips. For example, as discussed above, when buying a jar of pickles, one may be provided with a promotion for a second jar of pickles. An advertisement, on the other hand, may be an attempt by advertisers and P/S providers to target customers for goods based on their purchase histories. For example, based on the user's purchasing of a jar of pickles from the P/S provider A, an advertisement may display, to the user, other products/services provided by P/S provider A that may interest the user. Said in other words, a promotion leads directly to sales, whereas an advertisement is an assumption that it will lead to sales.

In one or more embodiments, the credit/debit card module (311) may be configured to store credit/debit card information associated with the user based on user input/preference. The credit/debit card information may comprise a credit/debit card number, an expiration date, a security code, etc. In one or more embodiments, the credit/debit card module (311) may be further configured to store other payment information including gift cards, bank account information, store credits, etc.

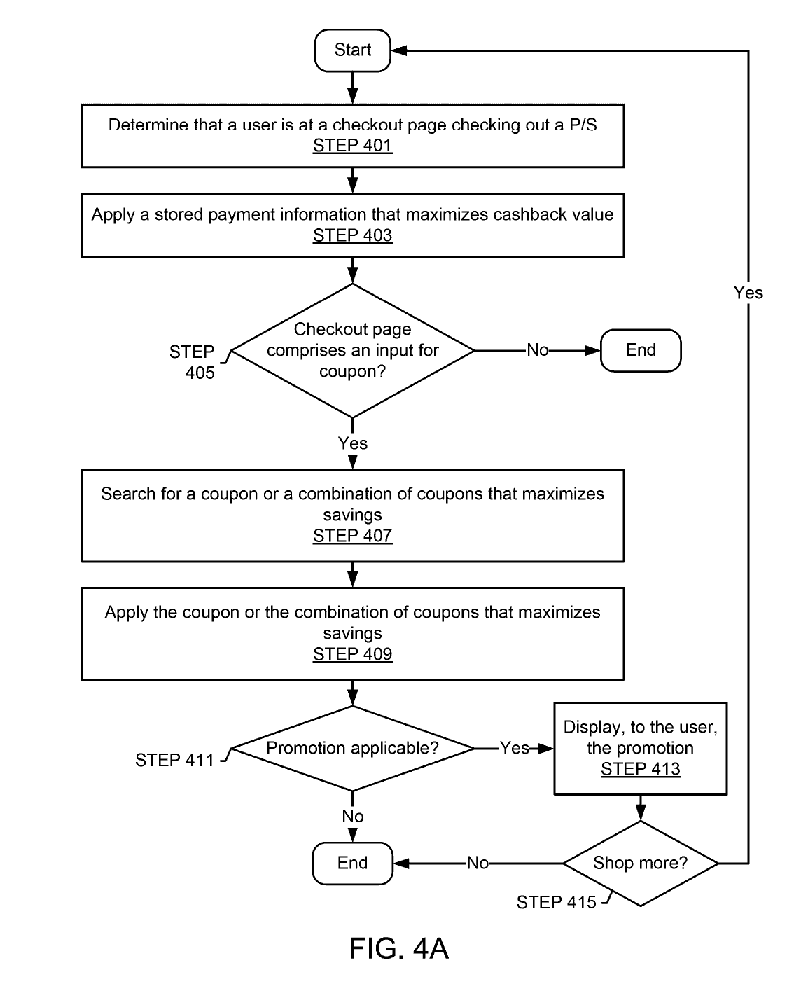

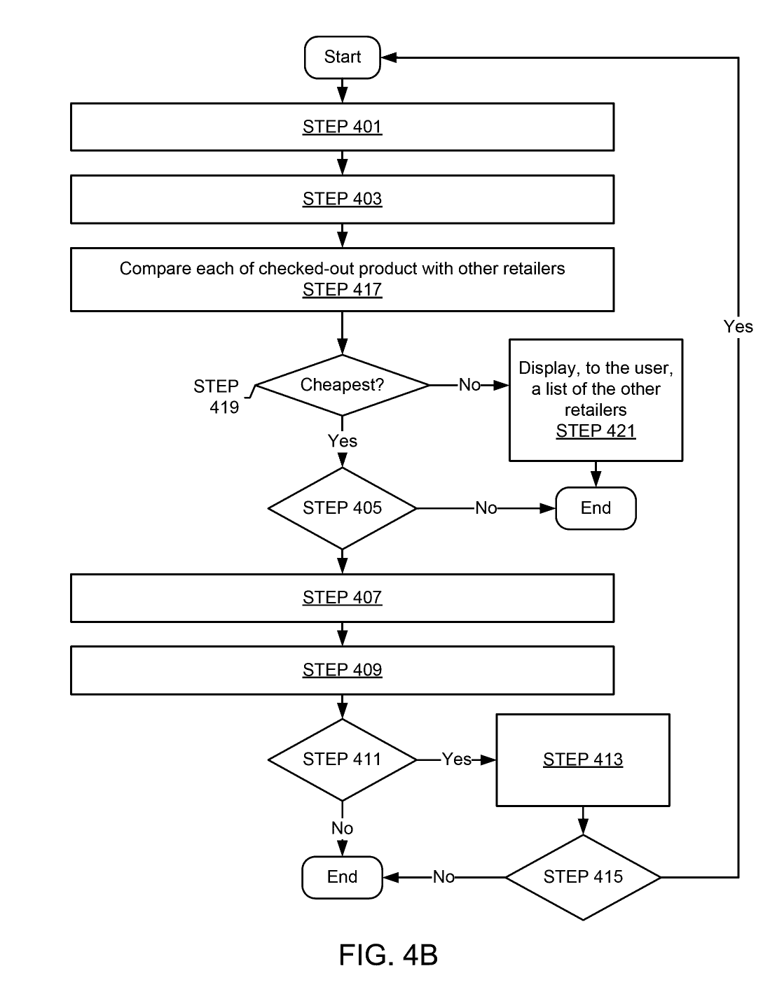

In one or more embodiments, the comparison module (313) may be configured to compare the purchase price to alternative purchase options. That is, upon detecting that a user is about to complete a purchase of a t-shirt from P/S provider A, the comparison module (313) may determine whether P/S provider A is providing the t-shirt at the lowest available price out of all P/S providers. If P/S provider B is able to provide the same product at a lower price, the user is appropriately informed of the alternative option. More details are described in reference to FIGS. 4A and 4B.

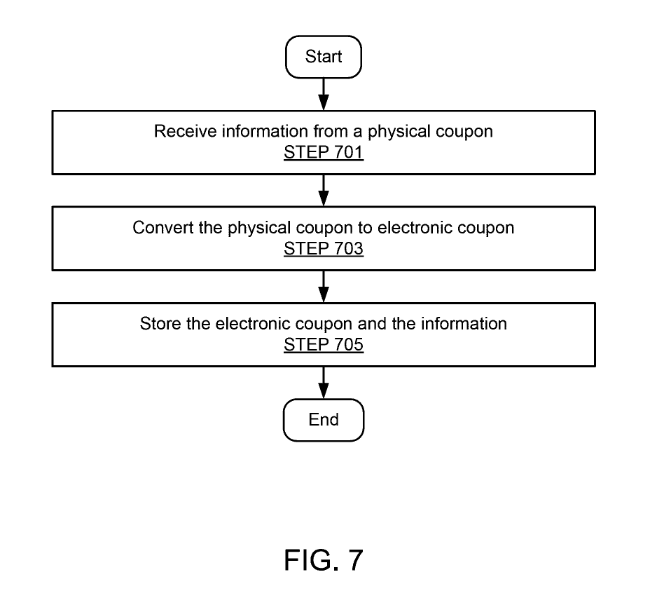

In one or more embodiments, the coupon module (315) is configured to crawl for coupons associated with the purchase. However, as not all coupons can be applied to the purchase (some combination of coupons may or may not be permitted), the coupon module (315) may use emulation to determine (1) whether the coupon is accepted by the P/S server and (2) whether the coupon or coupon combination is the lowest possible out of all crawled coupons. In one or more embodiments, the coupon may be stored for future use. In one or more embodiments, physical coupons (317) may be converted into electronic coupons and stored in the coupon module (315) for future use. In one or more embodiments, the unique identification code of the coupon, the expiration date of the coupon, the merchant accepting the coupon, and other relevant information associated with the coupon may be stored. A method for converting coupon according to one or more embodiments is described in more details in reference to FIG. 7.

FIG. 3C shows a portion of a shopping assistant server according to one or more embodiments of the present invention. Specifically, FIG. 3C shows some components of the product module (303), which may include a warranty module (319), a return label module (321), a return policy module (323), and a product history module (325).

In one or more embodiments, the warranty module (319) is configured to store warranty information associated with a purchase. Specifically, stored warranty information may include warranty expiration date, warranty conditions, etc.

In one or more embodiments, the return label module (321) is configured to generate return labels for products purchased. Of course, one of ordinary skill in the art would appreciate that not all purchases may be returned and that only items eligible for return can have their labels generated using the return label module (321).

In one or more embodiments, the return policy module (323) is configured to store return policy information associated with a purchase. Similar to the stored warranty information, some of the return policy information stored in the return policy module (323) may include last return date, return conditions, etc.

In one or more embodiments, the product history module (325) is configured to list all purchases purchased in the past. Information stored in this module may include the date of the purchase, reviews of the purchase, etc.

FIG. 3D shows a portion of a shopping assistant server according to one or more embodiments of the present invention. Specifically, FIG. 3D shows some components of the social media module (305), which may include a feed module (327), an advertisement module (331), an advisory module (329), and a discover module (333).

In one or more embodiments, the feed module (327) may be configured to store user information associated with the SAS server (103). For example, the feed module (327) may be configured to store information including how a user has purchased a blanket on Monday at 3:24 PM. Depending on the user's privacy setting, the purchase may be broadcasted such that other individuals interacting with the SAS server (103) may also be able to see the purchase by the user. The feed module (327) may further comprise comments, inputs, etc., directed to the purchase.

In one or more embodiments, the advertisement module (331) may be configured to provide advertisements to the user using the computing device (101). The advertisement may be selected based on the user's purchase history. Alternatively, or in addition, the advertisement may be selected using real-time bidding. In one or more embodiments, the advertisement may or may not be native. In one or more embodiments, predefined areas of an application associated with the SAS server (103) may be designated as advertisement placements.

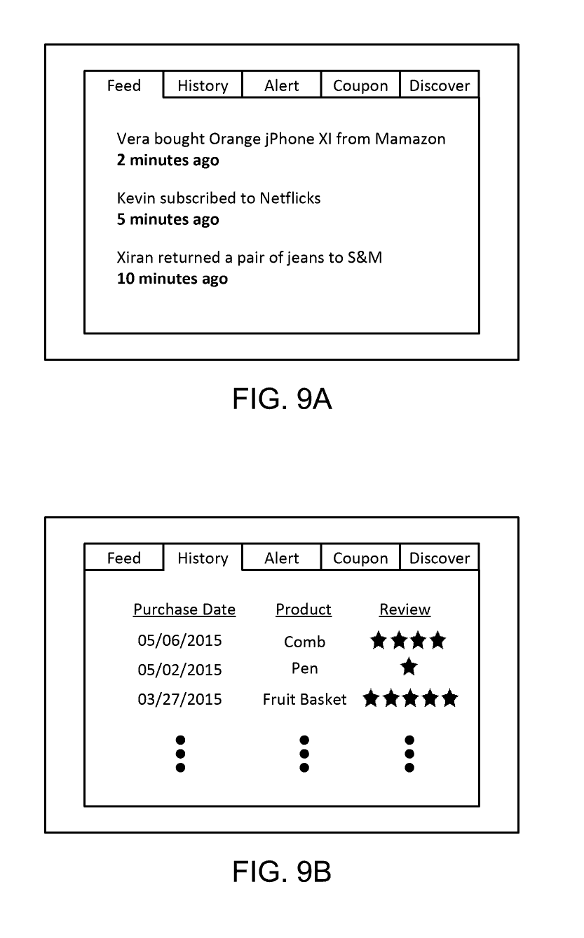

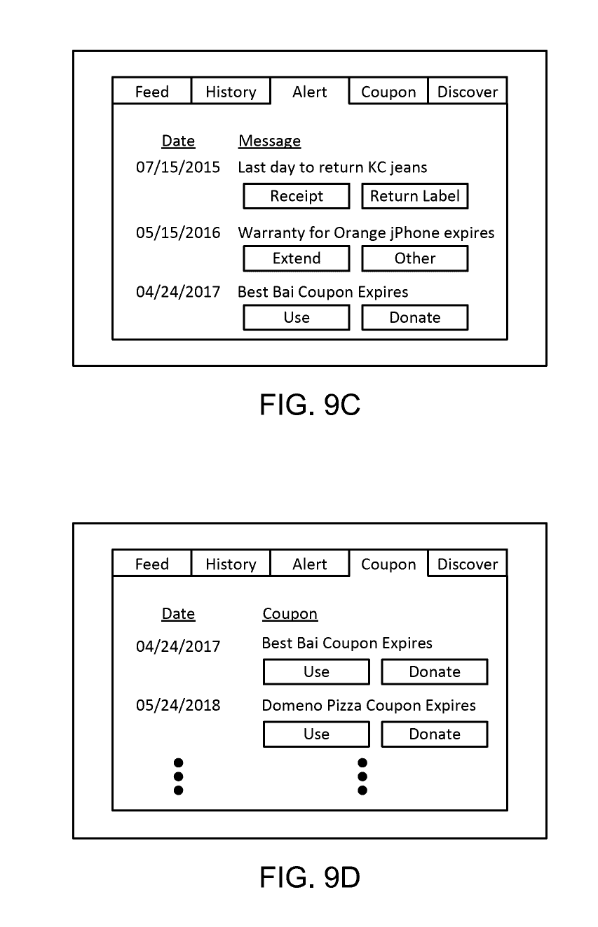

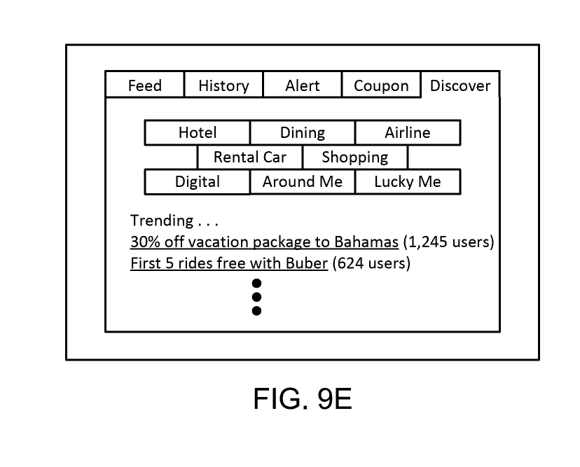

In one or more embodiments, based on the information pulled from, for example, the rebate module (307), the promotion module (309), the credit card module (311), the comparison module (313), the coupon module (315), the warranty module (319), the return label module (321), the return policy module (323), and the product history module (325), the advisory module (329) may be configured to display information that advises a user when the warranty for a purchase is to expire, when the last day to return a purchase is, when a coupon is to expire, what credit card has been underutilized, when the last day to submit a rebate is, etc. The information may be compiled as a report. A detailed example of the advisory module (329) is described in reference to FIG. 9C.

In one or more embodiments, the discover module (333) is configured to compute, store, and display trending information. The discover module (333) is also configured to store and display friend information (i.e., friend circle). For purposes of this application, a friend circle is defined as individuals who are connected and/or are associated through the SAS server (103).

In one or more embodiments, the trending information may be based on geofencing (i.e., information obtained geographically). The trending information may be divided using purchase categories (e.g., travel, dining, etc.). The trending information may be based on a count of users. The trending information may be obtained in a plurality of ways; the disclosure will not attempt to exhaustively list the means for gathering trending information for the sake of brevity. In one or more embodiments, the discover module (333) is configured to compile and display trending information.

In one or more embodiments, a group of friends may be connected via their respective computing devices while interacting with the SAS server (103). Thus, the SAS server (103) may determine that, out of friends A, B, and C, A bought a pair of shoes. In one or more embodiments, the discover module (333) may display to friends B and C that A recently bought a pair of shoes.

Turning to the flowcharts, while the various steps in the flowcharts are presented and described sequentially, one of ordinary skill will appreciate that some or all of the steps may be executed in different orders, may be combined or omitted, and some or all of the steps may be executed in parallel.

FIG. 4A shows a shopping assistant method according to one or more embodiments of the present invention. The method may be implemented by the SAS server (103).

In Step 401, the SAS server (103) determines that a user is at a checkout page purchasing a product/service. Specific means for accomplishing this step is not limited. For example, a pixel (embedded on the checkout page) may fire and provide the SAS server (103) with notification that a user has landed at a checkout page. Alternatively, Step 405 may occur first to determine that the user has landed at a checkout page. In the latter case, Step 403 may be performed subsequent to Step 405.

In Step 403, a stored payment is applied to the purchase. Specifically, in one or more embodiments, the SAS server (103) may first determine that the purchase belongs to a particular category. And, depending on the particular category, apply the appropriate credit card, for example, to maximize a cashback value. The appropriate credit card need not be the one that maximizes a cashback value, however. Depending on the user setting, it may be that the SAS server (103) determines that a user is only $50 away, in terms of spending, from fulfilling a sign-up bonus associated with the credit card. In this case, the user may be prompted by the system to use this particular credit card so as to expedite the process to unlock the sign-up bonus, which may or may not be greater than the cashback provided by the credit card that maximizes cashback value.

In Step 405, the SAS server (103) scans a page (whether in an application or in a browser) to determine whether there is an input for coupon, gift card, etc. If the system determines that there is such an input, the flowchart may proceed to Step 407. If the system does not determine that there is such an input, the flowchart may end. However, one of ordinary skill in the art would appreciate that not all coupons are derived from entering codes. Specifically, in one or more embodiments, the coupons can be unlocked by specific access paths (i.e., landing on the confirmation page using a designated URL, etc.). In this case, even if the system does not detect an input, the system may, based on the amount, the product, and other relevant information, crawl for better deals elsewhere (as explained in FIG. 4B below) or use emulation to determine the optimal path to the confirmation page. If it is determined that a specific URL would yield a lower price on the checkout page for the same item, the user may be provided with the specific URL.

In Step 407, the SAS server (103) crawls the internet and/or searches existing databases for applicable coupons and applies each of the applicable coupons to the checkout page to lower the price of the purchase. In one or more embodiments, the SAS server (103) may use emulation to determine which one of the coupon or which one of the combination of coupons enables the user to save the most on the purchase.

In Step 409, upon finding such a coupon or the combination of coupons, the coupon or the combination of coupons may be automatically applied. In one or more embodiments, the user may be provided with the option to see all coupon combinations. In one or more embodiments, the user may, from all the coupon combinations, select the combination that he or she would like to utilize to make the purchase.

In Step 411, the SAS server (103) may determine whether a promotion is applicable. The definition of promotion has been set forth above and will not be repeated for the sake of brevity. If the SAS server (103) determines that there is an applicable promotion based on the purchase, the flowchart may proceed to Step 413. Otherwise, the flowchart may simply end.

In Step 413, the SAS server (103) has determined that there is a promotion and, in turn, displays the promotion.

In Step 415, the user is provided with the option to continue checkout as is or else elect to see the promotion in detail and continue shopping. If the user decides to continue the checkout procedure, the user may be returned to the checkout page to complete his or her checkout. Alternatively, if the user elects to continue shopping, the flowchart returns to Start.

FIG. 4B shows a shopping assistant method according to one or more embodiments of the present invention. The method shown in FIG. 4B is substantially similar to that of FIG. 4A. Steps that have already been described are omitted for the sake of brevity.

In Step 417, the SAS server (103) compares the purchase price (may or may not be after the application of coupons, rebate, cashback rewards, etc.) to other retailers that are selling the same item. In one or more embodiments, the user may be able to specify the display of similar, and not necessarily identical, items. For example, instead of displaying Fuji apples from retailer B as the user has initially checked out from retailer A, the SAS server (103) may provide the user with the option to purchase lady finger apples from retailer B at a lower price compared to Fuji apples from retailer A (either because retailer B does not carry Fuji Apples or because of the user's particular setting.).

In one or more embodiments where the SAS server (103) compares the purchase price after the application of various coupons, rebates, cashback rewards to other alternative purchases, the SAS server (103) seeks to maximize the coupon savings, the rebate amount, and the cashback rewards. One of ordinary skill in the art would appreciate that, depending on the retailer, the applicable coupons, rebate, cashback rewards may differ. Thus, in proceeding, the SAS server (103) may first determine a total value of the current checkout page by subtracting coupon amount, rebate amount, and cashback amount from the purchase amount. Likewise, the SAS server (103) may conduct similar calculations and crawl coupons and rebates for alternative retailers and arrive at an other total amount. Comparing the other total amount with the total value, the SAS server (103) is able to present the user with various purchase comparisons. The calculations may be completed using emulation.

In Step 419, the SAS server (103) determines whether the purchase price is the cheapest out of all available retailers. If the purchase is the cheapest, then the flowchart proceeds to Step 405. If the purchase in not the cheapest, then the flowchart proceeds to Step 421.

In Step 421, the SAS server (103) compiles a list of alternative purchases (i.e. alternative purchase options). The list of alternative purchases may include only those that are cheaper than the purchase price. Alternatively, the list may include all available merchants for the user to see.

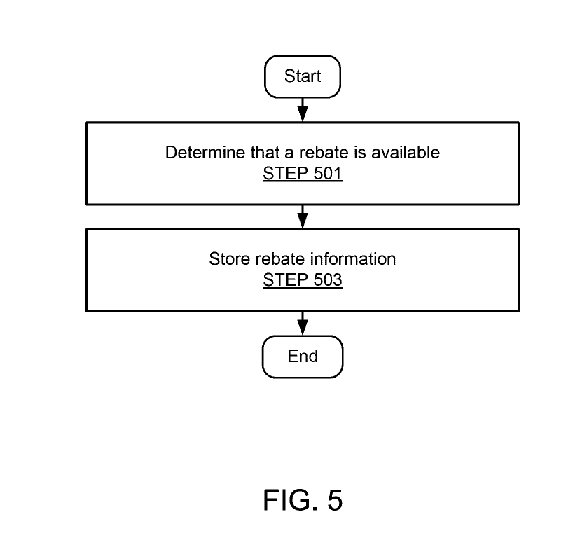

FIG. 5 shows a shopping assistant method according to one or more embodiments of the present invention.

In Step 501, the SAS server (103) first determines what product/service is being checked out. Once determined, the SAS server (103) determines whether a rebate is available for the P/S. In Step 501, the SAS server (103) determines that a rebate is available for the purchase.

In Step 503, information of the rebate is stored. In one or more embodiments the information may be stored in the rebate module (307), as described above. In one or more embodiments, the rebate information may only be stored when it has been further determined that the user has indeed purchased the P/S.

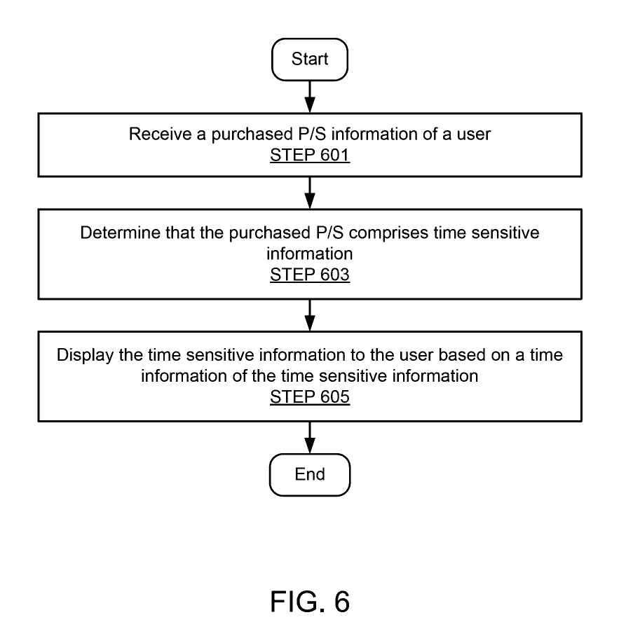

FIG. 6 shows a shopping assistant method according to one or more embodiments of the present invention.

In Step 601, the SAS server (103) receives a purchased P/S information. The P/S information may be the specific product purchased, the retailer of the product, the receipt number, the batch number, the international standard book number (ISBN), the universal product code (UPC), the international article number (EAN), the date of expiration, last day to return the product, warranty expiration date, etc.

In Step 603, the SAS server (103) receives/parses the PIS information and determines that certain information are time sensitive (e.g., expiration date, return shipping date, warranty expiration date, etc.).

In Step 605, the various information are sorted and presented to the user either on or before the expiration of the sensitive time. For example, if a purchased product's warranty expires on May 12, 2016, he or she may receive a notification on or before May 12, 2016. In one or more embodiments, the SAS server (103) may send notification to the user at a predetermined amount of time prior to the expiration date (i.e., a day before, a week before, a month before, etc.).

FIG. 7 shows a shopping assistant method according to one or more embodiments of the present invention.

In Step 701, coupon information is retrieved from a paper coupon. The information may be manually entered by the user, scanned using a photographic instrument (e.g., camera, smart phone, etc.). The coupon information may include, for example, coupon serial code, expiration date, value, applicable merchant, etc.

In Step 703, the coupon information is organized into a useable form. That is, the coupon information of the physical coupon is converted into an electronic coupon that can be readily scanned by, say, a supermarket clerk.

In Step 705, the coupon information is stored in the various relevant modules of the SAS server (103) to provide various functions to users as described above,

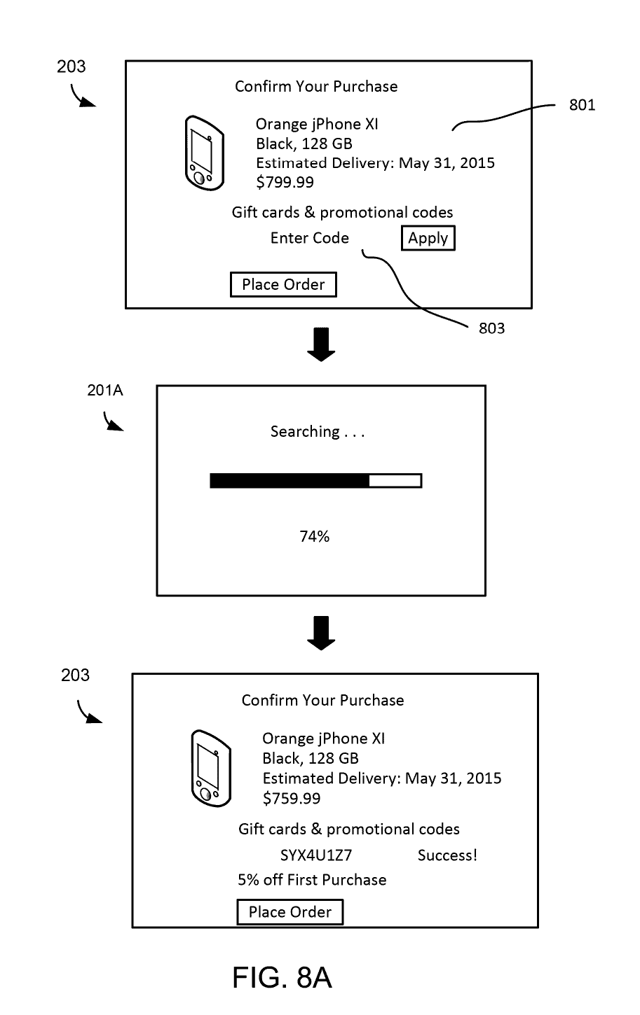

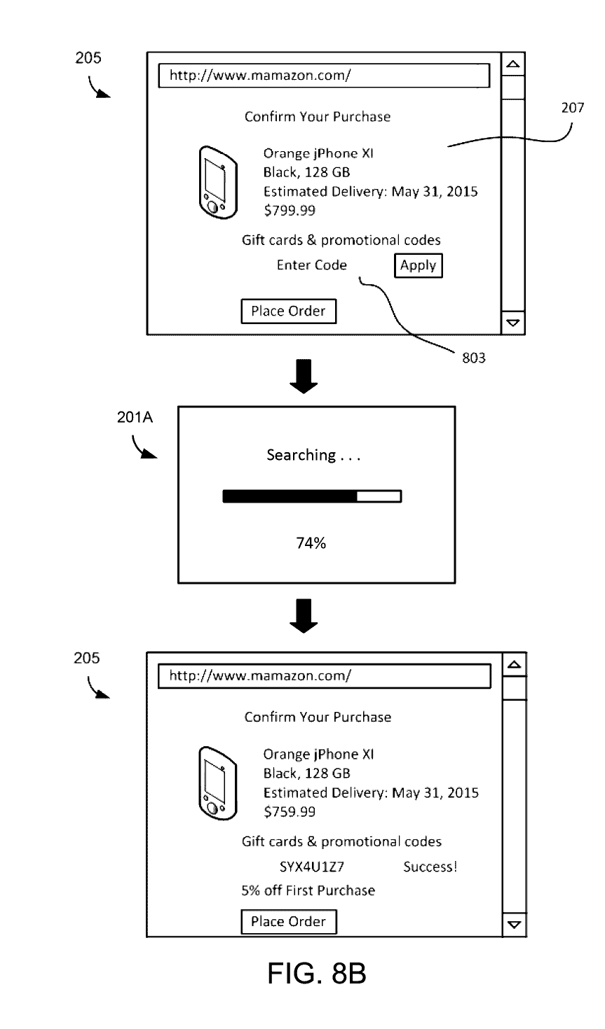

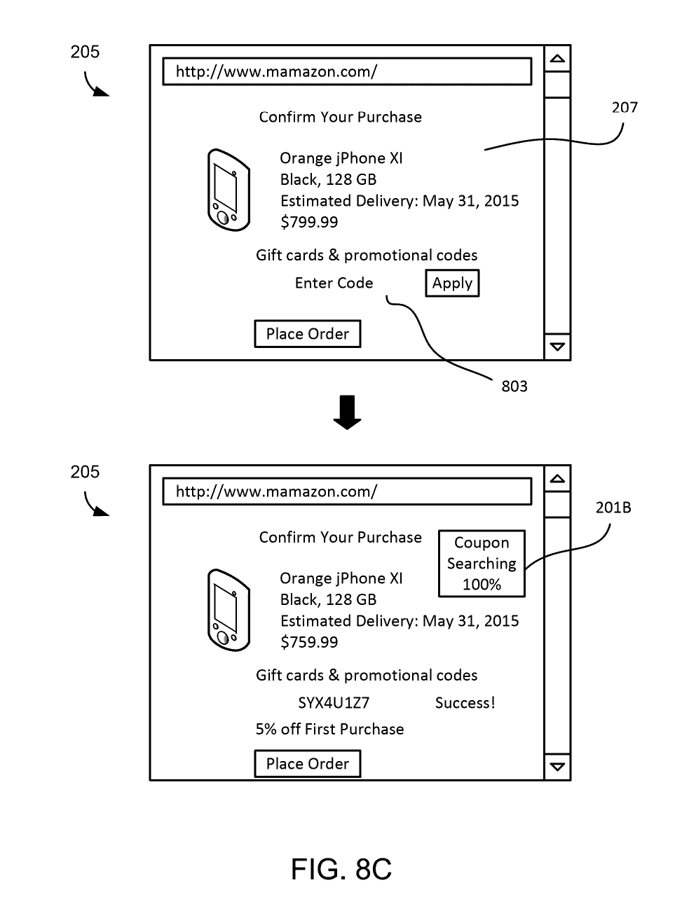

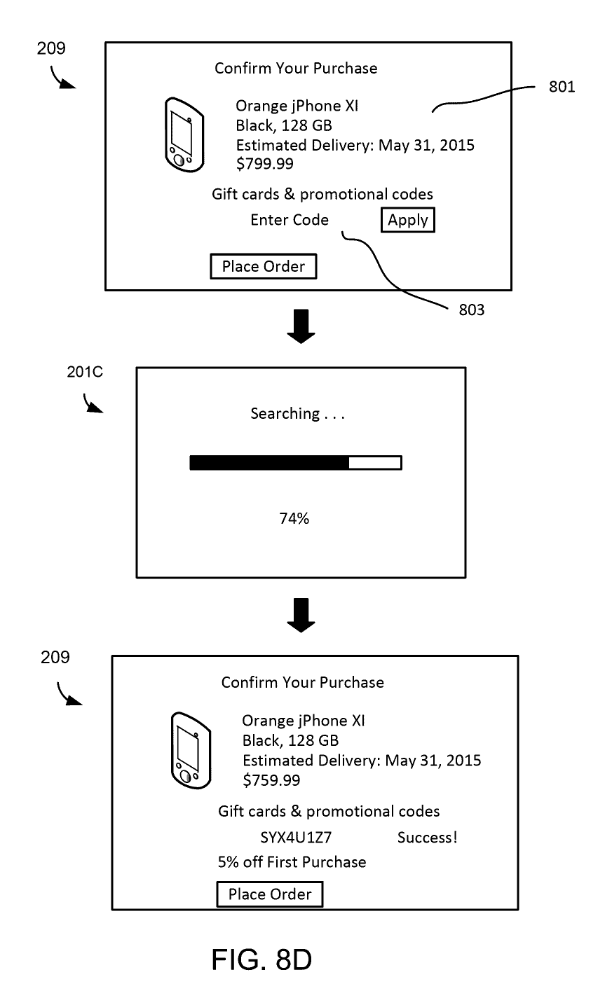

FIG. 8A shows a shopping assistant method according to one or more embodiments of the present invention. FIG. 8A shows one path in which the coupon searching function is activated and utilized—(1) P/S application (203), (2) SAS application (201A), and (3) P/S application (203).

Specifically, FIG. 8A shows a P/S application (203). The P/S application (203) is shown to display a checkout page (801) and an input (803) for coupon, gift card, etc. The SAS server (103) determines that the user is on the checkout page (801). Subsequently, the user is redirected to the SAS application (201A). Once coupons have been crawled and located by the SAS application (201A), the user is redirected back to the P/S application (203) with the coupons automatically inputted in the input (803).

FIG. 8B shows a shopping assistant method according to one or more embodiments of the present invention. FIG. 8B shows one path in which the coupon searching function is activated and utilized—(1) browser (205), (2) SAS application (201A), and (3) browser (205).

Specifically, FIG. 8B shows a browser (205). The browser (205) is shown to display the P/S webpage (207) and the input (803). The SAS server (103) determines that the P/S webpage (207) is a checkout page (801). Subsequently, the user is redirected to the SAS application (201A). Once coupons have been crawled and located by the SAS application (201A), the user is redirected back to the browser (205) with the coupons automatically inputted in the input (803).

FIG. 8C shows a shopping assistant method according to one or more embodiments of the present invention. FIG. 8C shows that the coupon searching function is activated and utilized within the browser (205).

Specifically, FIG. 8C shows a browser (205). The browser (205) is shown to display the P/S webpage (207) and the input (803). The SAS server (103) determines that the P/S webpage (207) is a checkout page (801). Subsequently, an SAS component (201B) is activated to conduct crawling of coupons. The SAS component (201B) may be a tag, a script, an extension, a plug-in, etc. Once coupons have been crawled and located by the SAS component (201B), the coupons are automatically inputted in the input (803).

FIG. 8D shows a shopping assistant method according to one or more embodiments of the present invention. FIG. 8D shows one path in which the coupon searching function is activated and utilized—(1) P/S UI (209), (2) SAS UI (201C), and (3) P/S UI (209).

Specifically, FIG. 8D shows a P/S UI (209) which may be within the P/S application (203) or the browser (205). The P/S UI (209) is shown to display the checkout page (801). Consequently, the user is redirected to the SAS UI (201C). Once coupons have been crawled and located by the SAS UI (201C), the user is redirected back to the P/S application (203) or the browser (205) (wherever the user is originally from) with the coupons automatically inputted in the input (803).

FIG. 9A shows an application associated with the shopping assistant system of FIG. 1. Specifically, FIG. 9A shows the SAS application (201A) having a plurality of tabs—feed, history, alert, coupon, discover, etc. In FIG. 9A, the tab “feed” is being displayed.

In the “feed” tab, the user is able to see all users' activities within the SAS server (103). Alternatively, the user is able to see only the activities of those he or she is acquainted with (i.e., friend circle). The friend circle may be friends connected on a social-media platform. Otherwise, the friend circle may be established by virtue of determining that both users have each others' phone numbers stored, that both users have added one another on the SAS system, etc. The privacy setting of an individual determines what is displayed in the “feed” tab.

FIG. 9B shows an application associated with the shopping assistant system of FIG. 1. Specifically, FIG. 9B shows the SAS application (201A) having a plurality of tabs—feed, history, alert, coupon, discover, etc. In FIG. 9B, the tab “history” is being displayed.

In the “history” tab, the user is able to see all his or her purchases that have been associated with the SAS server (103) in the past. Information including, for example, product name, purchase date, receipt number, product review from others, own product review, etc. may be displayed (subject to the user's setting).

FIG. 9C shows an application associated with the shopping assistant system of FIG. 1. Specifically, FIG. 9C shows the SAS application (201A) having a plurality of tabs—feed, history, alert, coupon, discover, etc. In FIG. 9C, the tab “alert” is being displayed.

In the “alert” tab, the user able to see all alerts for upcoming deadlines. Further, for each associated alert, the user may activate certain functions. For example, the entry Jul. 15, 2015 shows the message “Last day to return KC jeans.” Associated with the message are two actions “Receipt” and “Return Label.” The “Receipt” action, when clicked on by the user, leads the user to the receipt of the associated purchase. The “Return Label” action, when clicked on by the user, leads the user to the return label that he or she can print and utilize to return the KC jeans. Certain actions lead the user to other pages within the SAS application (201A), Certain actions lead the user to another application within the computing device (101). Certain actions lead the user to a browser within the computing device (101). One of ordinary skill in the art would appreciate that the functions available are not limited to those described above.

FIG. 9D shows an application associated with the shopping assistant system of FIG. 1. Specifically, FIG. 9D shows the SAS application (201A) having a plurality of tabs—feed, history, alert, coupon, discover, etc. In FIG. 9D, the tab “coupon” is being displayed.

In the “coupon” tab, the user is able to see all coupons that he or she has stored/saved. The coupons may be those converted from physical coupons as discussed in reference to FIG. 7. In the same tab, an expiration date is displayed along with possible functions for each coupon. For example for the Best Bai coupon that is set to expire Apr. 24, 2017, the actions “Use” and “Donate” are available. The “Use” action may subsequently lead the user to the Best Bai application using mobile deeplink. However, if it is determined that the Best Bai application is not installed on the same computing device, the user may be led to a download page and be prompted to download the Best Bai application or may be led to a browser displaying the Best Bai webpage. In the latter case, an HTTP GET request is submitted to the Best Bai partner server and the Best Bai webpage is subsequently displayed. Likewise, the “Donate” action may lead the user to an application or a browser, where he or she is able to subsequently gift the coupon or donate it to a 3^{rd} party entity or a friend from the friend circle.

FIG. 9E shows an application associated with the shopping assistant system of FIG. 1. Specifically, FIG. 9E shows the SAS application (201A) having a plurality of tabs—feed, history, alert, coupon, discover, etc. In FIG. 9E, the tab “discover” is being displayed.

In the “discover” tab, the user able to see trending coupons. For example, coupons that have been most utilized (i.e., either in terms of the general population, or in terms of specific friend circles, etc.). For example, coupons that have been promoted by their relevant partners. The coupons in the tab may be divided into various categories so that the user is able to navigate the page with ease. The user is also able to search for coupons that are applicable for PIS providers nearby. Additionally, the user is also able to search for coupons that are exclusively available for online purchases. Furthermore, the user is able to click on the “Lucky Me” button and receive a random coupon.

While the disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because many other architectures can be implemented to achieve the same functionality.

The process parameters and sequence of steps described and/or illustrated herein are given by way of example only. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While the disclosure has been described with respect to one or more embodiments of the present invention, those skilled in the art, having benefit of this disclosure, will appreciate that other embodiments can be devised which do not depart from the scope of the disclosure as disclosed herein.

For example, one of ordinary skill in the art would appreciate that the functions of the SAS server (103) are not limited to those described above. Specifically, the SAS application (201A) may enable a user to scan P/S using UPC, ISBN, etc., to retrieve information on the goods. The scan may be utilized by any photographic instrument (e.g., camera, smart phone, etc.). Otherwise, the user may input UPC, ISBN, etc., manually. The information retrieved may include price, complementary goods, promotions, location of the goods within a particular venue (i.e., supermarket aisle, etc.), a list of retailers that sell the goods, expiration date, nutritional value, coupons, product review, customer loyalty program, related credit card issuers/credit cards, related gift cards, etc.

For example, the SAS server (103) may periodically crawl, either wired or wirelessly, for coupons. The crawling behavior can correspond to a user's purchasing history, a user's activity, etc. For example, if the SAS server (103) determines that a user has been active on shopping site A, he or she may periodically be provided with coupons from shopping site A.

For example, the advertisement module (331) may be configured to display advertisements anywhere in the application associated with the SAS server (103) including, but not limited to, when the user is converting a physical coupon to an electronic coupon. The advertisement displayed may be based on the user's purchasing behavior, browsing behavior, etc.

For example, the advertisement module (331) may be configured to display advertisements based on items stored in a wish list, shopping cart, etc.

For example, one of ordinary skill in the art would appreciate that certain sites enable a user to place items in a wish list, shopping cart, etc. In one or more embodiments, the SAS server (103) may be configured to crawl for coupons and update the user when coupons become available for certain items in the wish list, shopping cart, etc.

For example, one of ordinary skill in the art would appreciate that an application associated with the SAS server (103) may be configured to provide a platform for users to buy and sell second hand goods. The platform may comprise bidding mechanisms, discussion forums, chatrooms, and other relevant features.

Furthermore, one of ordinary skill in the art would appreciate that certain “components,” “units,” “parts,” “modules,” “elements,” or “portions” of the one or more embodiments of the present invention may be implemented by a circuit, processor, etc., using any known methods. Accordingly, the scope of the disclosure should be limited only by the attached claims.

What is claimed is:

1. A system comprising:
a server having a processor and a database; and
a computing device configured to issue a request to the server,
wherein the database is configured to store purchase information, and
wherein the processor, upon receiving the request, is configured to:
determine a category of a purchase having a purchase price,
apply the purchase information to the purchase to maximize a first value,
identify a coupon having a second value that reduces the purchase price,
apply the coupon to reduce the purchase price by the second value, and
display, on the computing device, a reduced value.

2. The system according to claim 1, wherein the purchase information is at least one of a credit/debit card number, a gift card number, and a bank account number.

3. The system according to claim 1, wherein the processor is further configured to determine that a rebate having a third value is associated with the purchase.

4. The system according to claim 3, wherein the processor is further configured to:
calculate, using at least one of the first value, the second value, and the third value, a first total value,
compare the first total value to an other total value,
display on the computing device, if the first total value is not greater than the other total value, an alternative purchase, and
display on the computing device, if the first total value is greater than the other total value, the reduced value.

5. The system according to claim 1, wherein the processor is further configured to:
calculate, using at least one of the first value and the second value, a first total value,
compare the first total value to an other total value,
display on the computing device, if the first total value is not greater than the other total value, an alternative purchase, and
display on the computing device, if the first total value is greater than the other total value, the reduced value.

6. The system according to claim 5, wherein the processor compares the first total value to the other total value using emulation.

7. The system according to claim 1, wherein the processor identifies and applies the coupon using at least one of a script tag and an extension.

8. The system according to claim 1, wherein the processor identifies and applies the coupon using emulation.

9. The system according to claim 1, wherein, using merchant information associated with the purchase, the processor is further configured to display a promotion associated with the purchase.

10. The system according to claim 1, wherein the request is issued to the server after the computing device determines that a user is at a checkout page.

11. A method comprising:
determining that a user is at a checkout page for a purchase;
determining a category of the purchase having a purchase price;
applying a purchase information stored in a database to the purchase to maximize a first value;
identifying a coupon having a second value that reduces the purchase price;
applying the coupon to reduce the purchase price by the second value; and
displaying a reduced value.

12. The method according to claim 11, wherein the purchase information is at least one of a credit/debit card number, a gift card number, and a bank account number.

13. The method according to claim 11 further comprising determining that a rebate having a third value is associated with the purchase.

14. The method according to claim 13 further comprising:
calculating, using at least one of the first value, the second value, and the third value, a first total value;
comparing the first total value to an other total value;
displaying, if the first total value is not greater than the other total value, an alternative purchase; and
displaying, if the first total value is greater than the other total value, the reduced value.

15. The method according to claim 11 further comprising:
calculating, using at least one of the first value and the second value, a first total value,
comparing the first total value to an other total value,
displaying, if the first total value is not greater than the other total value, an alternative purchase,
displaying, if the first total value is greater than the other total value, the reduced value.

16. The method according to claim 15, wherein the comparing uses emulation.

17. The method according to claim 11, wherein the identifying and the applying the coupon use at least one of a script tag and an extension.

18. The method according to claim 11, wherein the identifying and the applying the coupon use emulation.

19. The method according to claim 11 further comprising displaying a promotion associated with the purchase using merchant information.

20. A non-transitory computer readable medium comprising computer readable program code, which when executed by a computer processor, enables the computer processor to:
determine that a user is at a checkout page for a purchase;
determine a category of the purchase having a purchase price;
apply a purchase information stored in a database to the purchase to maximize a first value;
identify a coupon having a second value that reduces the purchase price;
apply the coupon to reduce the purchase price by the second value;
calculate, using at least one of the first value and the second value, a first total value;
compare, using emulation, the first total value to an other total value;
display, if the first total value is not greater than the other total value, an alternative purchase;
display, if the first total value is greater than the other total value, the reduced value;
display a promotion associated with the purchase using merchant information; and
display an advertisement associated with the purchase using the merchant information.
